(19) United States
(12) Patent Application Publication
(10) Pub. No.: US 2013/0018672 A1
(43) Pub. Date: Jan. 17, 2013

(54) Method And Apparatus For Providing Telemedicine Services

(71) Applicants: David Wong, Palo Alto, CA (US); Rajnish Gupta, Sunnyvale, CA (US); Arun Rajan, Las Vegas, NV (US); Laurent Bortolamiol, San Jose, CA (US)

(72) Inventors: David Wong, Palo Alto, CA (US); Rajnish Gupta, Sunnyvale, CA (US); Arun Rajan, Las Vegas, NV (US); Laurent Bortolamiol, San Jose, CA (US)

(21) Appl. No.: 13/184,149

(22) Filed: Jul. 15, 2011

(51) Int. Cl. G06Q 50/24

(52) U.S. Cl. 705/3

(57) ABSTRACT

A method and apparatus is disclosed for providing remote dermatological services that are integrated with a patient records management system.

### FIELD

The embodiments relate generally to a method and apparatus for providing remote dermatological services that are integrated with a patient records management system.

### BACKGROUND

Telemedicine is well-known in the prior art, particularly in the field of radiology. One of the benefits that was touted early in the development of the Internet was the potential to provide medical services to remote locations where a doctor would interact with a patient remotely and provide a diagnosis without physically being in the same room as the patient. Decades later, telemedicine still has not reached its full potential. In the field of dermatology, the progress has been particularly slow.

Dermatology is well-suited for telemedicine because many skin conditions can be diagnosed visually. What is needed is a system that allows a patient and/or his or her primary care provider to be able to take high-resolution photographs of a skin condition and upload them to a server along with patient records; assigns that patient's case to a dermatologist who satisfies certain criteria for treating that patient; and then allows a dermatologist to review the photographs and records, provide a written diagnosis and recommendation, and send the diagnosis and recommendation to the patient and/or his or her primary care provider.

### BRIEF DESCRIPTION OF THE DRAWINGS

FIG. 1 is a block diagram of an embodiment of a telemedicine system.

FIG. 2 is a screenshot of an exemplary web page of a telemedicine system for enabling a user to log on to the system.

FIG. 3 is a screenshot of an exemplary web page of a telemedicine system for managing patients.

FIG. 4A is a screenshot of an exemplary web page of a telemedicine system for inputting patient information.

FIG. 4B is a screenshot of an exemplary web page of a telemedicine system for inputting insurance information.

FIG. 5 is a screenshot of an exemplary web page of a telemedicine system for inputting medical history information.

FIG. 6A is a screenshot of an exemplary web page of a telemedicine system for inputting information of a specific skin condition.

FIG. 6B is a screenshot of an exemplary web page of a telemedicine system for inputting information of a specific skin condition.

FIG. 7 is a screenshot of an exemplary web page of a telemedicine system for uploading documents and photos.

FIG. 8 is a screenshot of an exemplary web page of a telemedicine system for a treating physician to log on to the system.

FIG. 9 is a screenshot of an exemplary web page of a telemedicine system for managing patients.

FIG. 10A is a screenshot of an exemplary web page of a telemedicine system for reviewing an active case.

FIG. 10B is a screenshot of an exemplary web page of a telemedicine system for reviewing an active case.

FIG. 10C is a screenshot of an exemplary web page of a telemedicine system for reviewing an active case.

FIG. 10D is a screenshot of an exemplary web page of a telemedicine system for reviewing an active case.

FIG. 10E is a screenshot of an exemplary web page of a telemedicine system for reviewing an active case.

FIG. 11 is a screenshot of an exemplary web page of a telemedicine system for displaying a patient chart.

FIG. 12 is a screenshot of an exemplary web page of a telemedicine system for displaying a patient profile.

FIG. 13 is a screenshot of an exemplary web page of a telemedicine system for listing patient documents.

FIG. 14 is a screenshot of an exemplary web page of a telemedicine system for displaying a patient's medical history chart.

FIG. 15 is a screenshot of an exemplary web page of a telemedicine system for providing a message inbox for the physician.

FIG. 16 is a block diagram of another embodiment of a telemedicine system.

FIG. 17 is a block diagram of another embodiment of a telemedicine system depicting a schematic of the. Scheduling Module.

FIG. 18 is a block diagram of another embodiment of a telemedicine system depicting the Input and Output management of the system.

FIG. 19 is a block diagram of another embodiment of a telemedicine system depicting Patient Search and Data in the system.

FIG. 20 is a block diagram of another embodiment of a telemedicine system depicting Multiple Complaints Workflow.

FIG. 21 is a block diagram of another embodiment of a telemedicine system depicting a Case Assignment and Scheduling Module.

FIG. 22 is a block diagram of another embodiment of a telemedicine system depicting a Multiple Complaints Consultation Module.

### DETAILED DESCRIPTION OF ONE OR MORE EMBODIMENTS

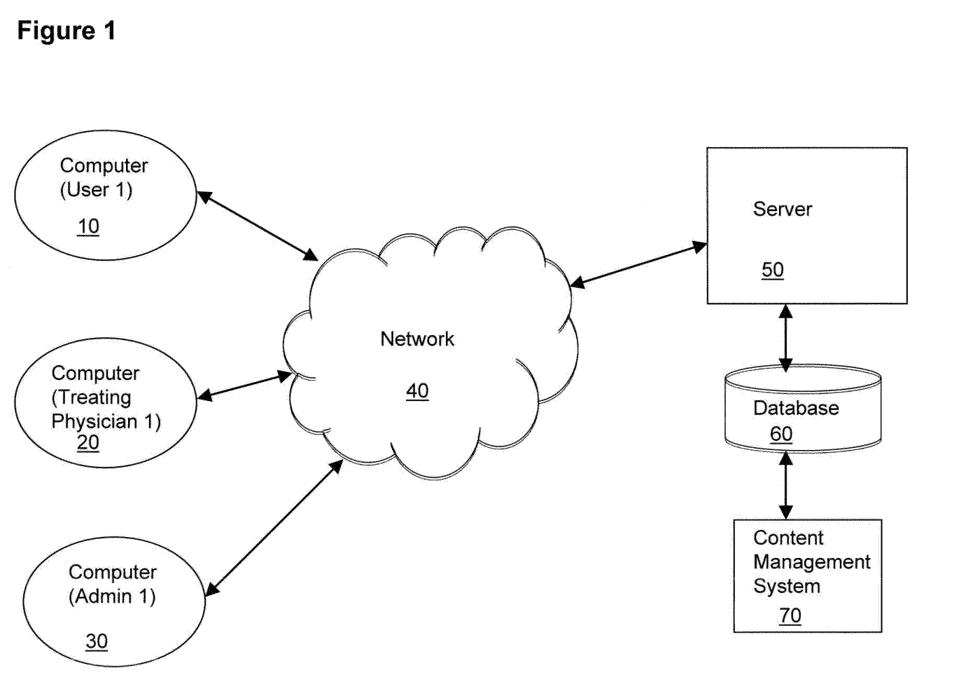

FIG. 1 depicts the top-level architecture of an embodiment. Computers 10, 20, and 30 connect to network 40. Computers 10, 20, and 30 can be desktops, notebooks, servers, mobile devices, PDAs, or any other type of computing device that can interact with a network. Computers 10, 20, and 30 typically each comprise a processing device, memory, non-volatile storage such as a hard disk drive or solid state drive, and a network interface.

In this example, computer 10 is operated by User 1, computer 20 by Treating Physician 1, and Computer 30 by Admin 1. User 1 can be a patient (Patient 1 in this example) or an individual who is interacting with the patient (Primary Physician 1, who is treating Patient 1 in this example). Computers 10, 20, and 30 are merely exemplary devices, and any number of similar computers with associated users (Patient 2, . . . Patient N; User 2, . . . User M; etc.) also can be connected to network 40 for the purposes described herein.

Computers 10, 20, and 30 connect to network 40 using any type of known network interface, such as Ethernet, USB, fibre channel, 802.11, CDMA, 3G, 4G, GSM, or other interfaces. Network 40 can be any type of network, such as the Internet, and can be hardwired, wireless, or some combination of the two.

Server 50 is also connected to network 40 using a network interface. Server 50 is a computing device that can interact with computers 10, 20, and 30. Server 50 typically comprises a processing device, memory, non-volatile storage such as a hard disk drive or solid state drive, and a network interface. Server 50 comprises a web server capable of serving web pages. Server 50 is coupled to database 60. Database 60 contains the content for the web pages that are served by server 50. For example, database 60 can contain web pages written in the HTML, XHTML, or XML languages and various style sheets. Database 60 is coupled to content management 70, which is a tool for managing the web content stored in database 60.

In this embodiment, server 50 operates a web-based platform for providing remote dermatological services. Computer 10 is operated by User 1, which again, might be Patient 1 or Primary Physician 1. Computer 20 is operated by Treating Physician 1, who is a dermatologist who will provide the dermatological services. Computer 30 is operated by Admin 1, who is a professional associated with the entity that manages server 50, database 60, and content management system 70. Patient 1 is an exemplary Patient for purposes of the exampled provided herein, and it is to be understood that there could be numerous Patients serviced by this system. Similarly, Primary Physician 1 is an exemplary Primary Physician, and Treating Physician 1 is an exemplary Treating Physician.

The Patient Side of the Telemedicine System

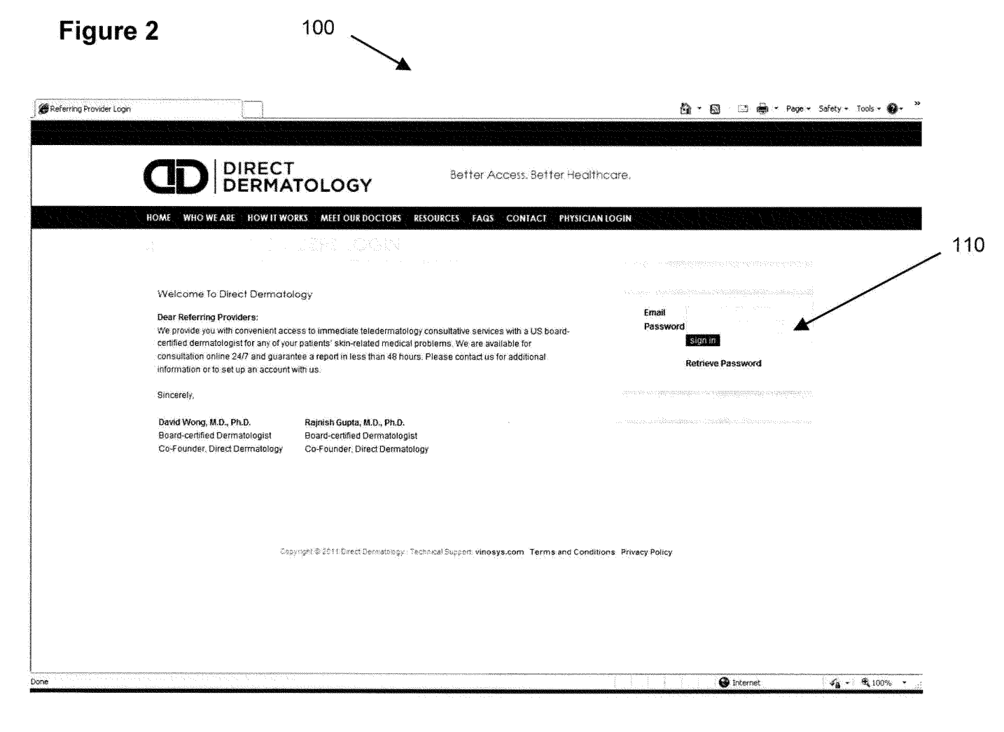

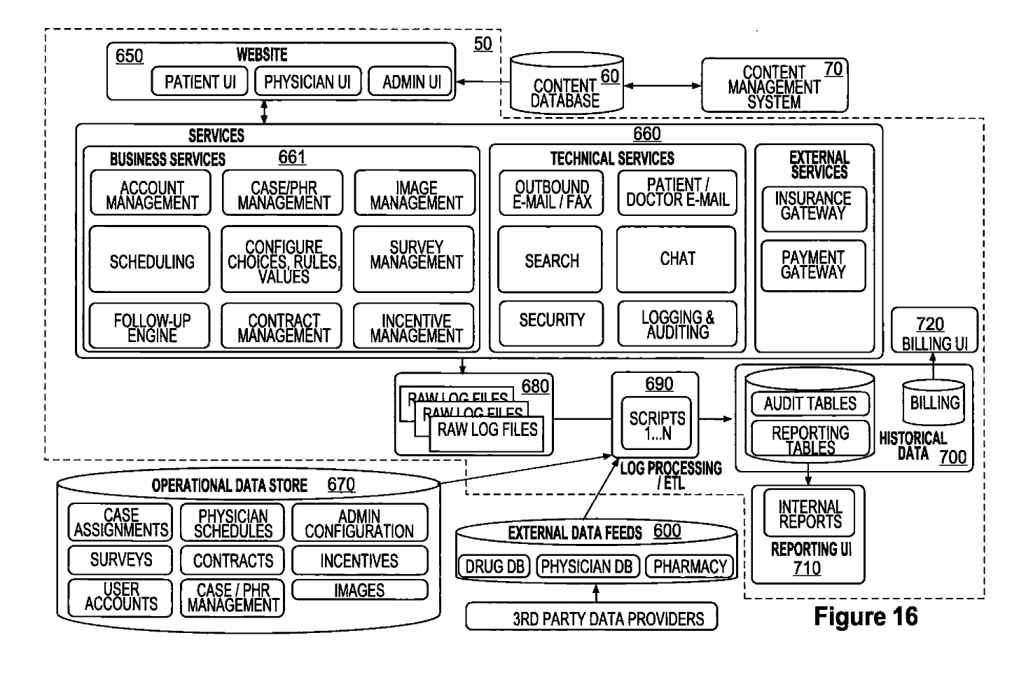

User 1 initiates the dermatological service by accessing a web page served by server 50. An exemplary screen shot of a home web page 100 is shown in FIG. 2. User 1 views this web page on computer 10 using a web browser, such as Microsoft Internet Explorer. Home web page 100 includes text boxes 110 for User 1 to provide his or her user name and password. After User 1 enters the user name and password, computer 10 sends that information to server 50 using well-known HTTP protocols. Server 50 then verifies the user name and password against user records contained in operational data store 670 (described below with reference to FIG. 16), and if verified, begins a session for User 1.

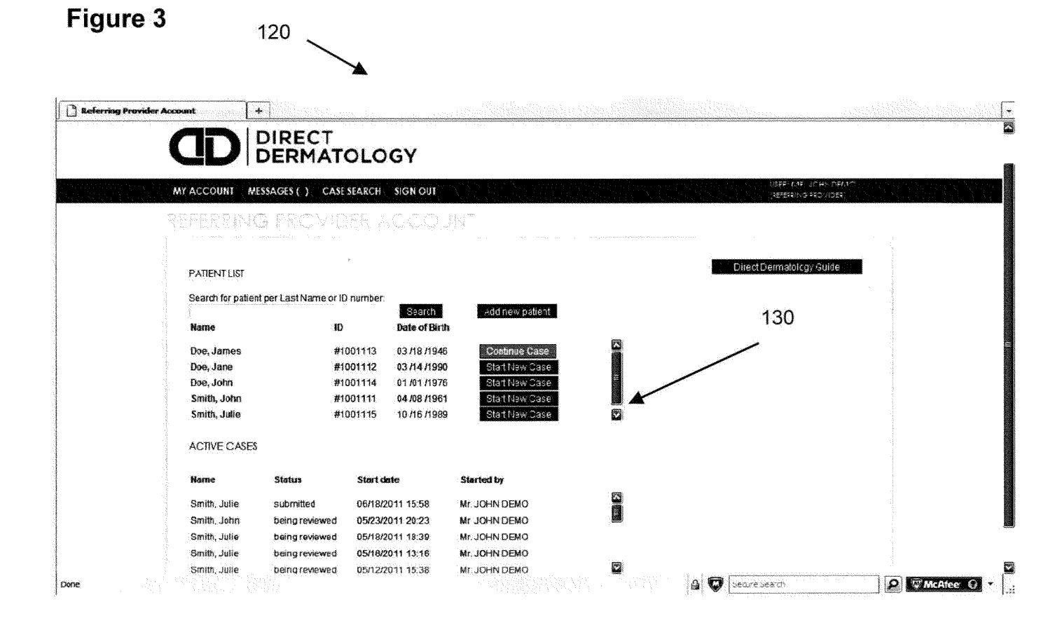

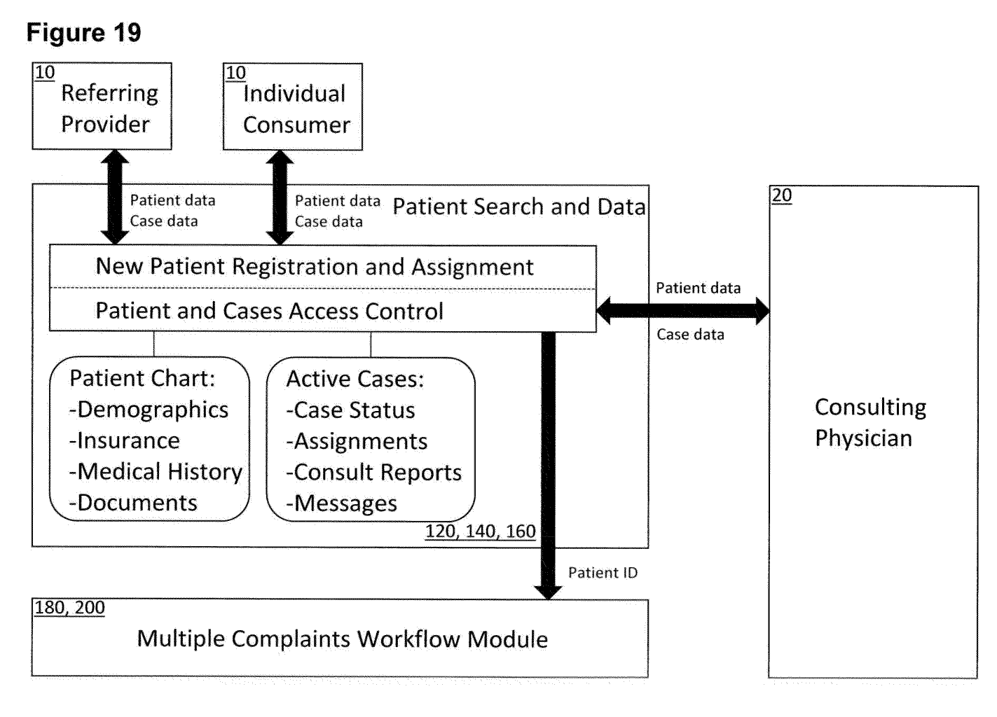

If User 1's user name and password are verified, server 50 can send another web page to computer 10. FIG. 3 shows exemplary page 120, which enables User 1 to continue a case for an existing patient (in the instance where User 1 is Primary Physician 1 who has more than one patient), start a new case for an existing patient, or to add a new patient using the user interface controls 130. Primary Physician 1 (if there is one) is assigned a unique identification number, referred to as Primary Physician ID, by server 50. FIG. 19 is a flow diagram showing some of the activities involved in gathering the data for and generating exemplary page 120.

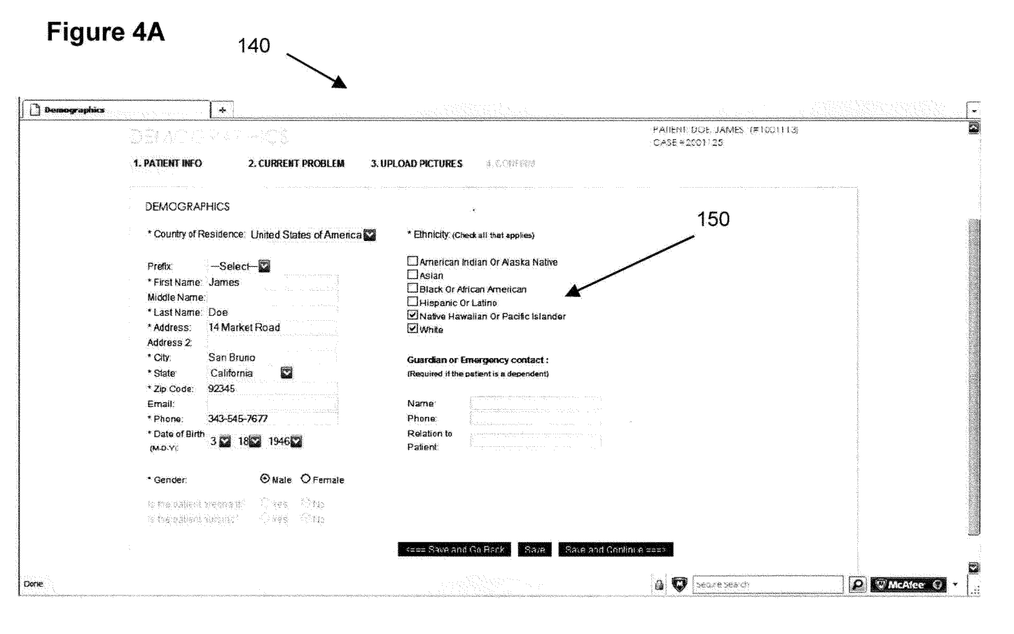

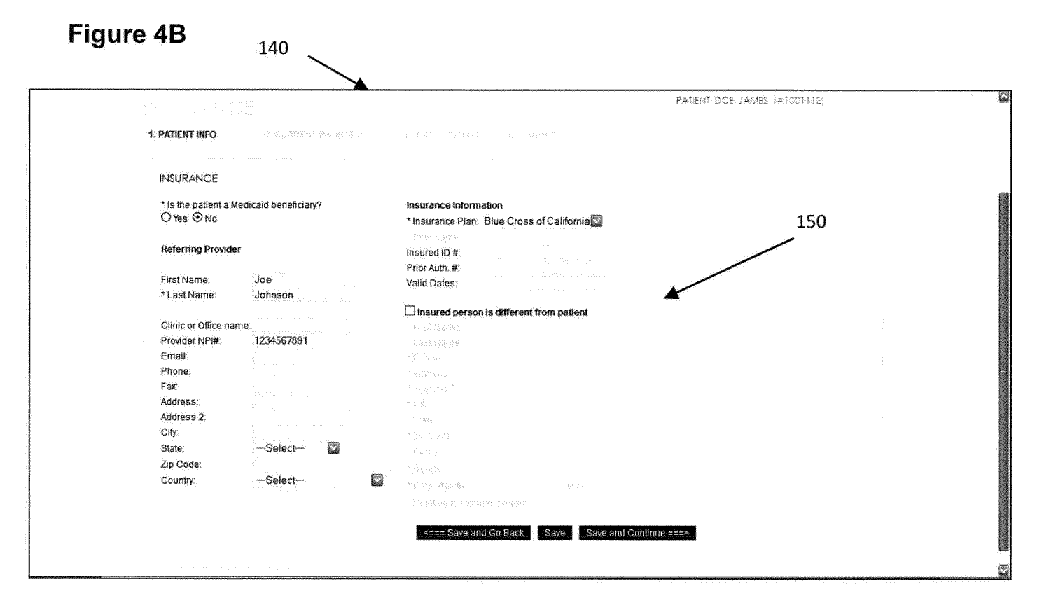

If User 1 selects the button “Add new patient” in FIG. 3, then web page 140, of which an exemplary screen shot is shown in FIGS. 4A and 4B, will be generated by server 50. Using exemplary web page 140, User 1 will enter personal and demographic information for Patient 1, such as name, address, email address, phone number, date of birth, gender, ethnicity, and emergency or guardian contact information, as well as insurance information, including referring provider, insurance plan, insurance member ID, and prior authorization number, using the user interface controls 150. Patient 1 is assigned a unique identification number, referred to as Patient ID, by server 50.

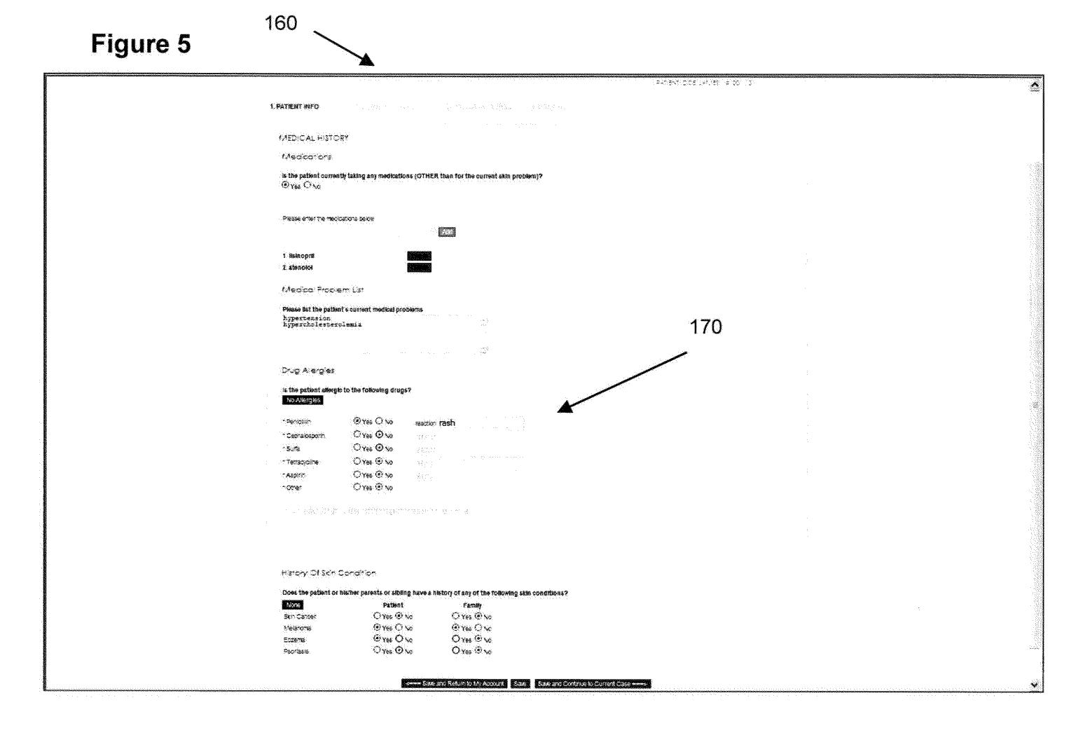

After User 1 enters the information required by exemplary web page 140, server 50 will then send exemplary web page 160, shown in FIG. 5. On this page, User 1 will enter Patient 1's medical history, such as medications currently taken, current medical problems, drug allergies, and history of skin conditions, using the user interface controls 170.

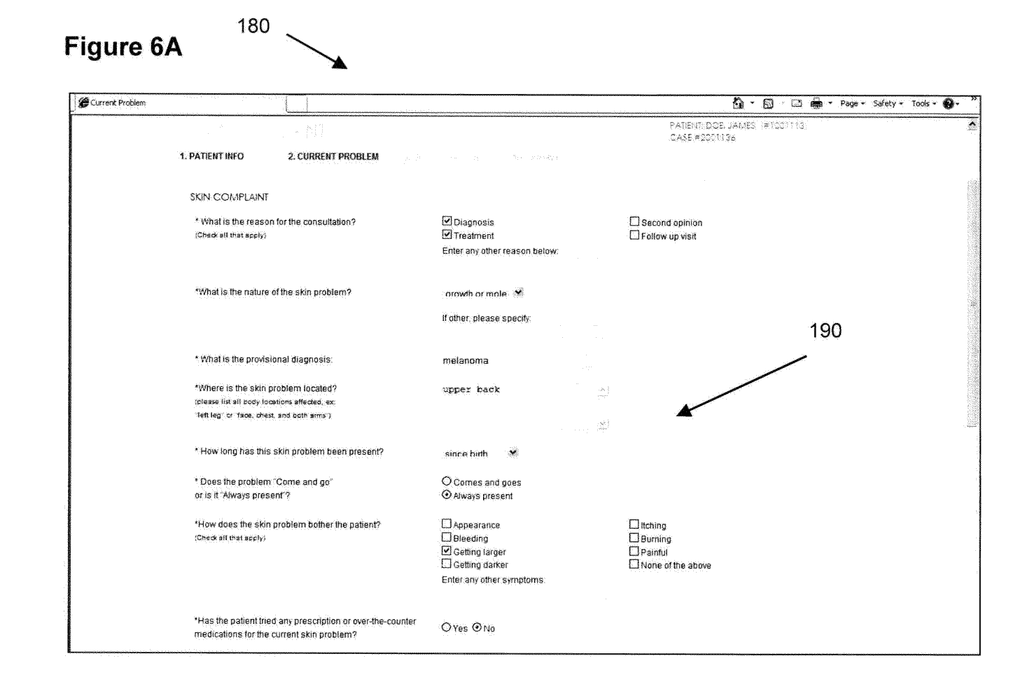

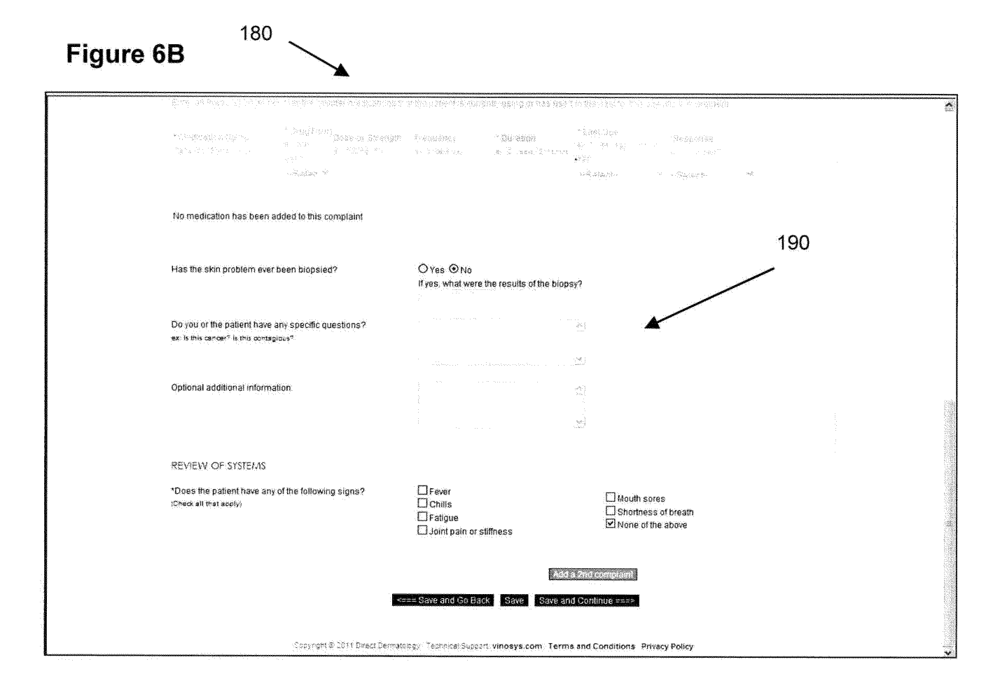

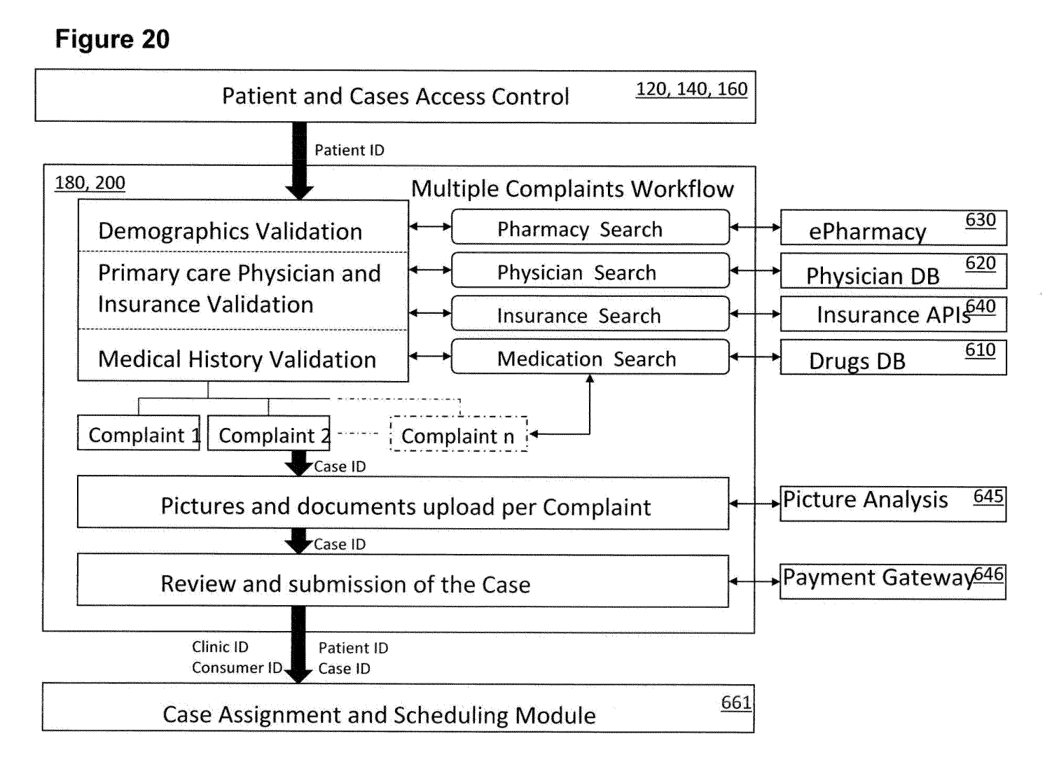

After entering the information requested by web page 160, server 50 generates exemplary web page 180, shown in FIGS. 6A, 6B and 20. On this page, User 1 will enter information about the specific skin condition for which diagnosis and treatment is sought. The information can include the reason for the consultation, the nature of the skin problem, any provisional diagnosis, the location of the skin problem, how long the skin problem has been present, the frequency of the skin problem, the nature of how the skin problem bothers the patient, whether the patient has tried medication for the skin problem and if so which types and how frequently, specific questions the patent has, general medical systems, and other information that User 1 wishes to provide. This information is entered using user interface controls 190. Server 50 assigned a unique identification number to this case, referred to as a Case ID.

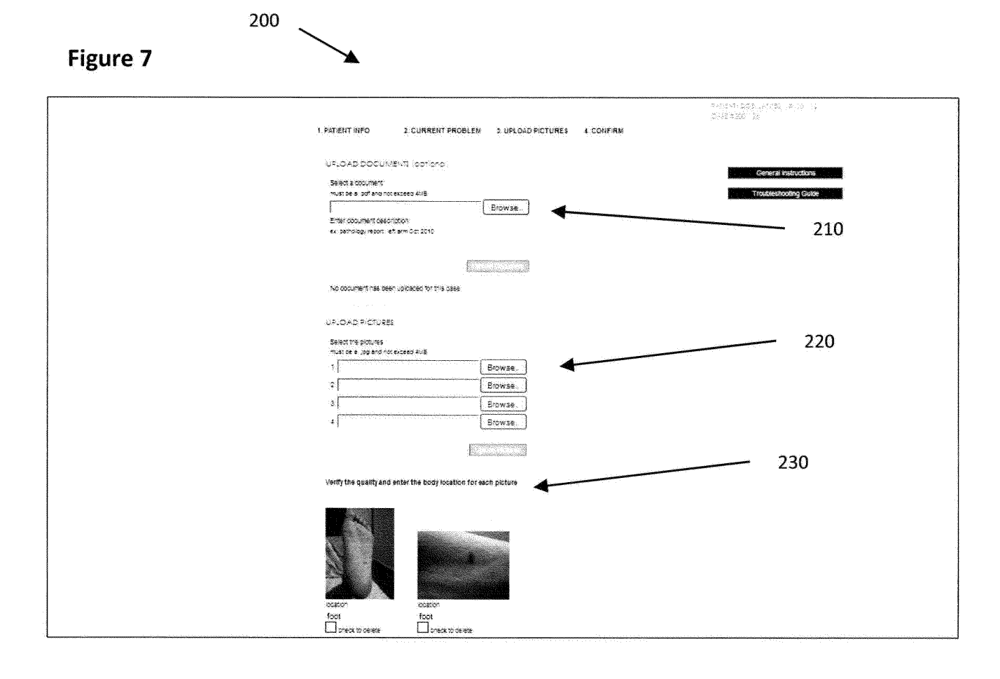

After entering the information requested by web page 180, server 50 generates exemplary web page 200, shown in FIGS. 7 and 20. On this page, User 1 will upload any documents that it wishes to send to the treating dermatologists, such as patient records, pathology reports, etc., using user interface controls 210. User interface controls 210 optionally include a browsing feature that allows User 1 to identify the specific document(s) to be uploaded within the file system of computer 10. User 1 also will upload one or more photographs of the skin problem, which User 1 will take using a camera (not shown here) and upload to computer 10. User 1 will upload one or more photographs using user interface controls 220. User interface controls 220 optionally include a browsing feature that allows User 1 to identify the specific photographs to be uploaded within the file system of computer 10. Once loaded, web page 200 dynamically will display the photos, and User 1 will then confirm the quality of photographs loaded and will describe the location of each depicted skin problem using user interface controls 230.

Meanwhile the picture analysis module 645 shown on FIG. 20 provides User 1 with picture quality information such as brightness, focus, resolution, validating the upload or prompting User 1 to upload better quality pictures (e.g., photos).

User interface controls optionally can include a tool for displaying a graphical image of a generic human body and enable User 1 to indicate the location of the skin problem on that graphical image using a graphical “X” or something similar. Once User 1 has completed entering the requested information, computer 10 will send the information and any attached documents and photographs to server 50 using well-known HTTP protocols. Server 50 will add the information, documents, and photographs to the records of this patient and this case, stored in operational data store 670, discussed in greater detail below.

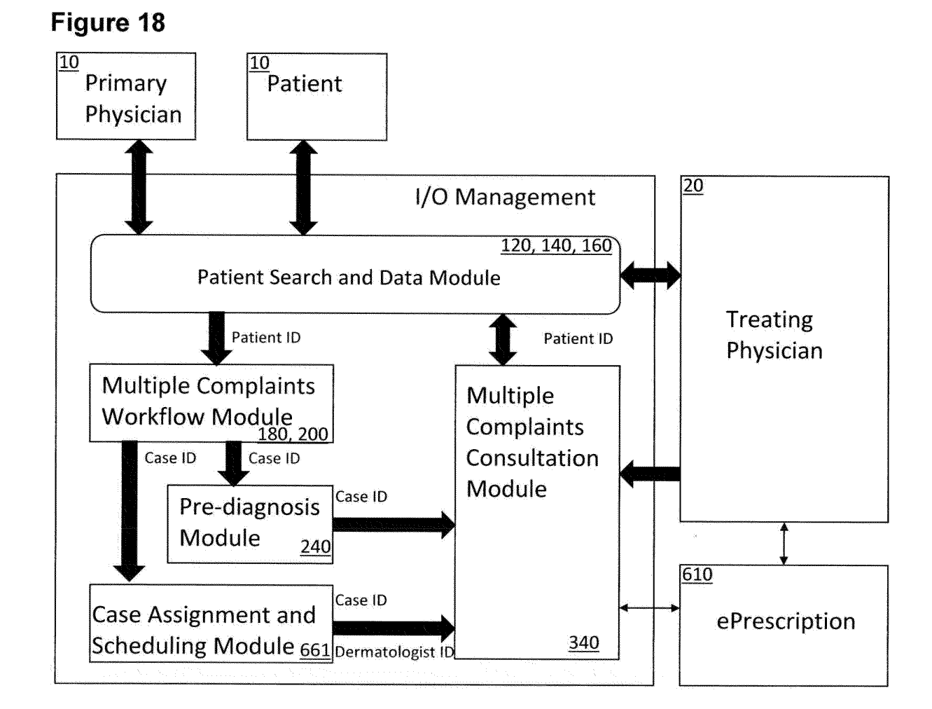

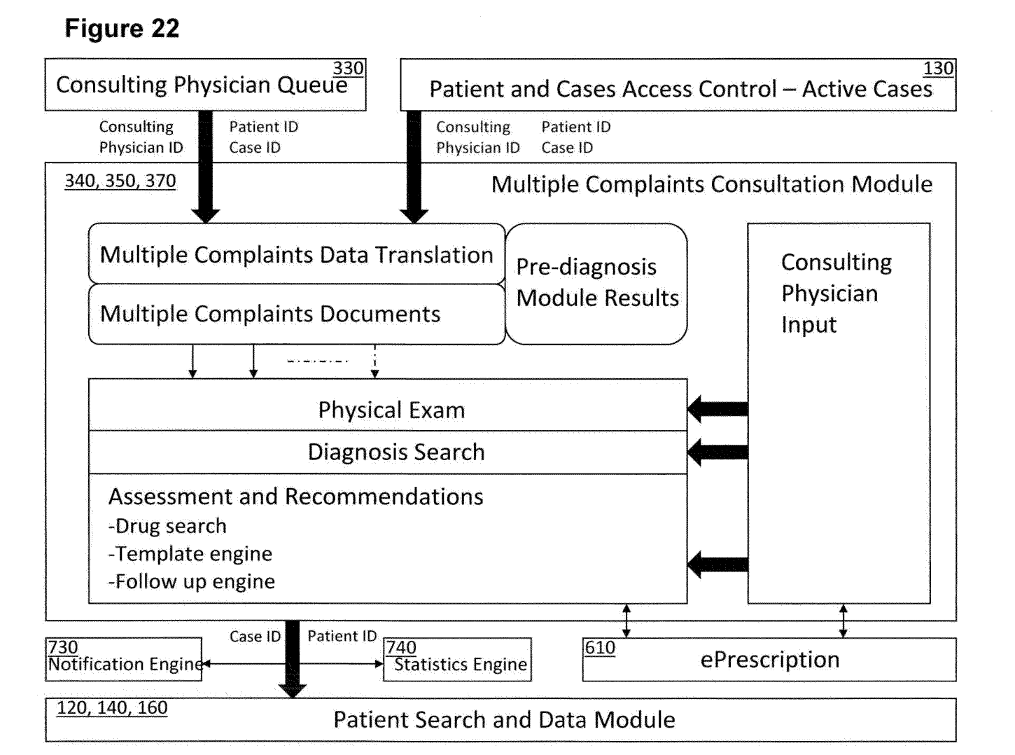

Pre-diagnosis Module 240, which comprises lines of code run by server 50, shown on FIG. 18 analyzes the case information contained in data store 670 and generates an automated diagnosis based on the pictures properties and case data. The pre-diagnosis is provided to Treating Physician 1 through the consultation module 340, which also comprises lines of code run by server 50, of FIG. 22

If User 1 is identified as a Patient (instead of a Primary Physician), User 1 will be prompted to provide payment information through payment gateway 646 shown on FIG. 20.

User interface controls 110, 130, 150, 170, 190, 210, 220, and 230 comprise web browser interfaces well-known to those of skill in the art, such as HTML or XHTML text boxes, menus, links, and buttons.

The Treating Physician Side of the Telemedicine System

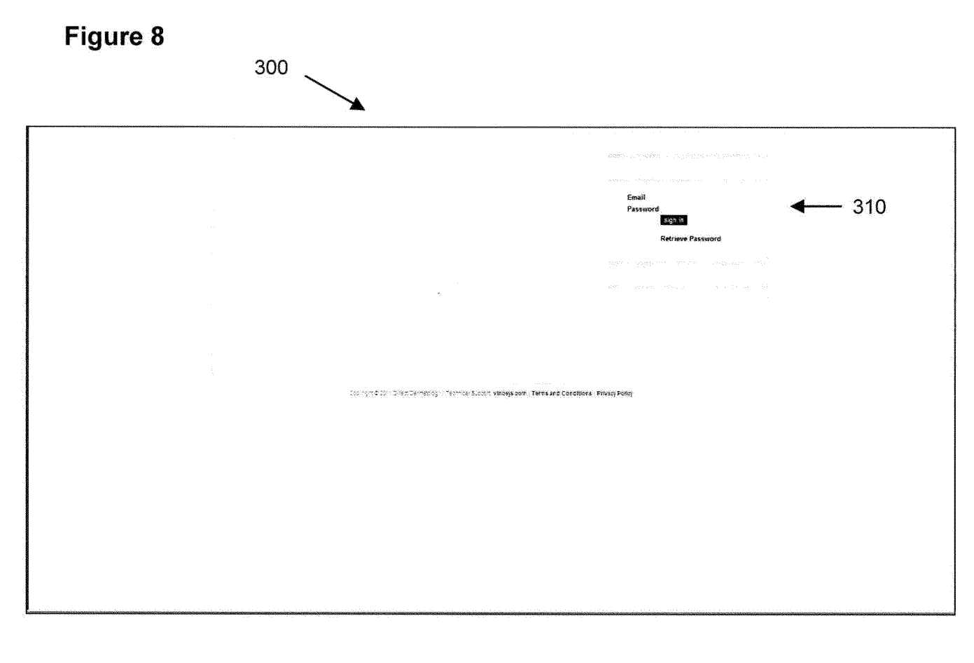

Treating Physician 1 typically will be a dermatologist who has been retained to provide dermatological services. Server 50 assigns a unique ID to Treating Physician 1, referred to as the Treating Physician ID. Treating Physician 1 will access a web page served by server 50. A screen show of an exemplary home web page 300 is shown in FIG. 8. Physician 1 views this web page on computer 20 using a web browser, such as Microsoft Internet Explorer. Home web page 300 includes user interface controls 310 for Physician 1 to provide his or her user name and password. After Physician 1 enters the user name and password, computer 20 sends that information to server 50 using well-known HTTP protocols. Server 50 then verifies the user name and password against user records contained in operational data store 670, and if verified, begins a session for Physician 1.

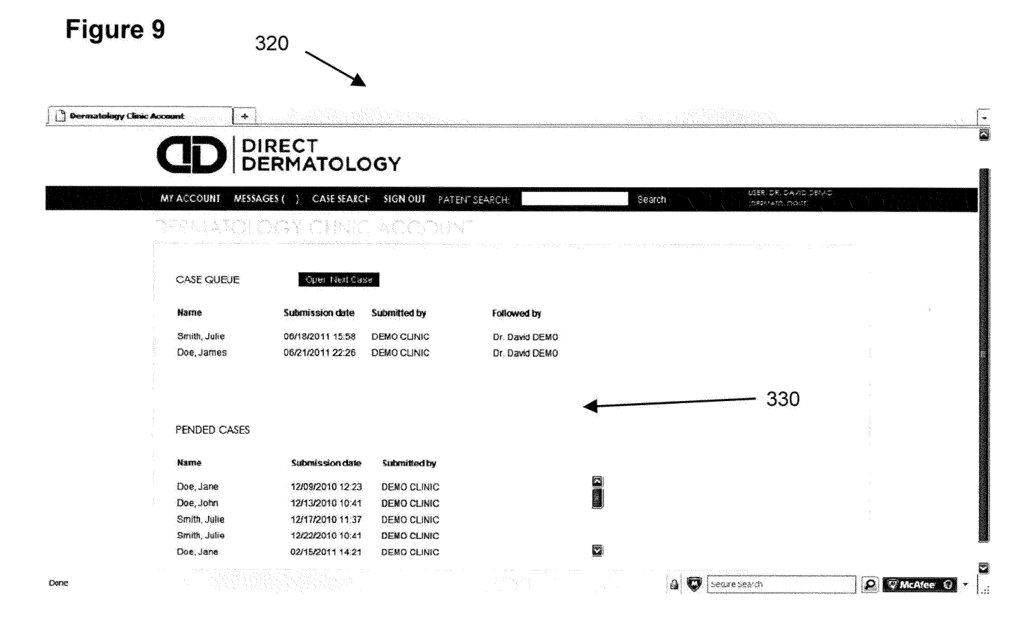

If Physician 1's user name and password are verified, server 50 can send another web page to computer 20. FIG. 9 shows a screen shot of exemplary web page 320. Web page 320 shows Physician 1's cases, which each correspond to a dermatological problem submitted by User 1 or other users. Web page 320 displays a “Case Queue,” which show new cases that Physician 1 has not yet reviewed, as well as “Pending Cases,” which show all cases that Physician 1 is in the process of reviewing. New cases are assigned to Physician 1 and placed in his or her queue using a methodology to be described below. From web page 320, Physician 1 can select a case to review using user interface controls 330.

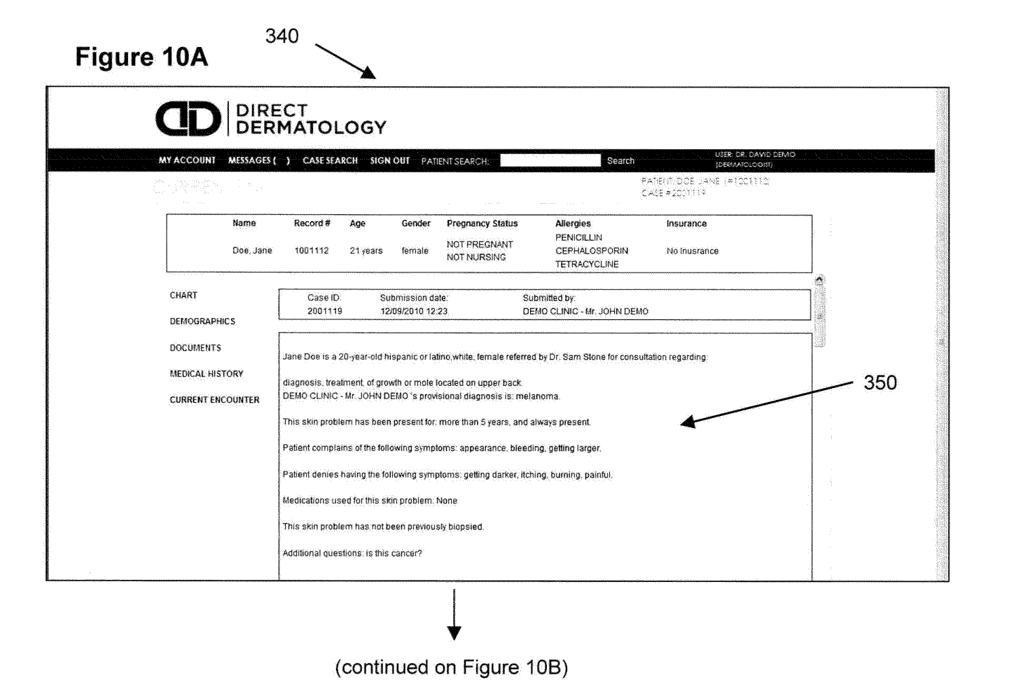

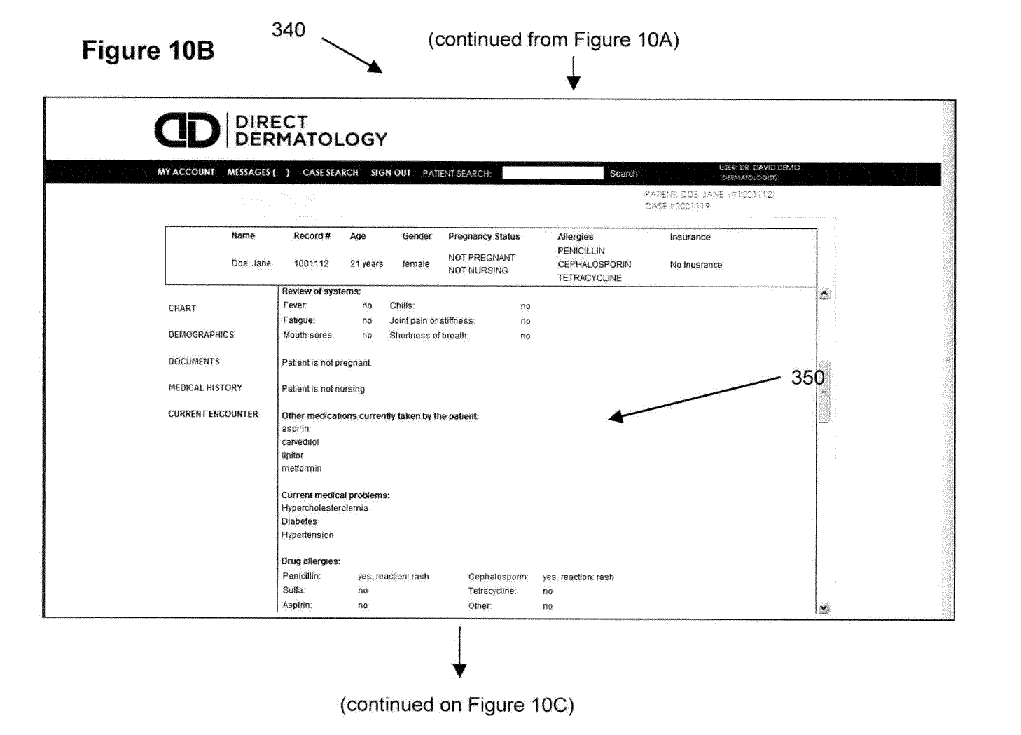

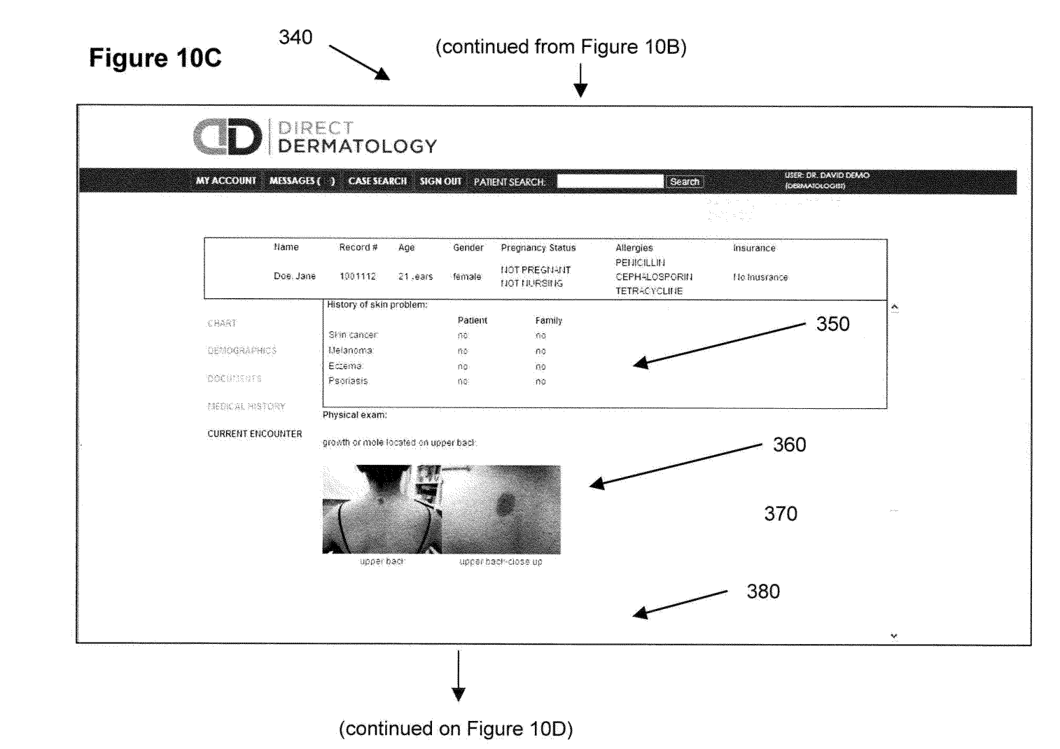

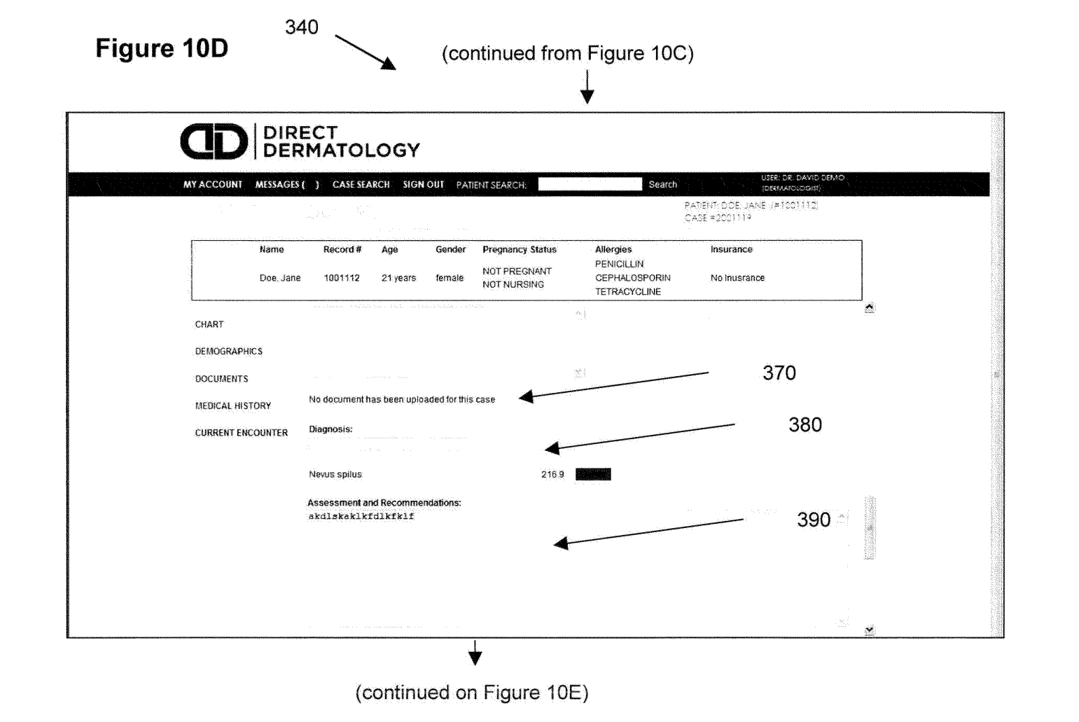

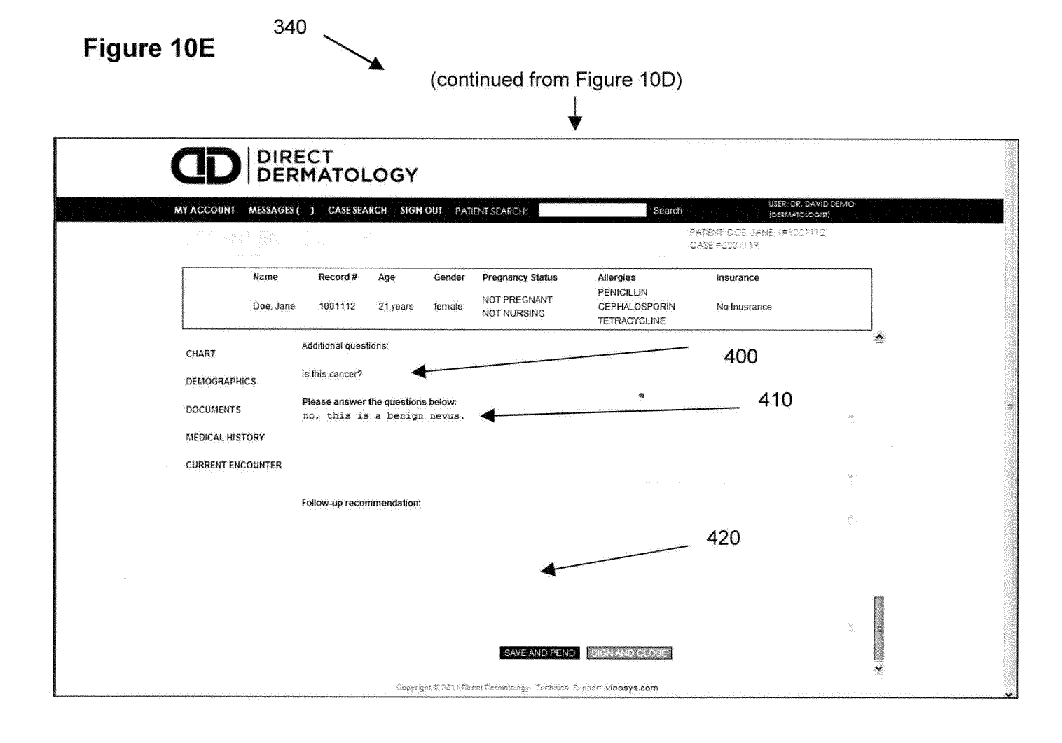

FIGS. 10A-10G and 22 show exemplary screen shots of web page 340, which in this example was generated when Physician 1 selected “Doe, Jane” in the “Pending Cases” list on web page 320. Information regarding the current case was automatically populated in web page 340 by server 50 based on information submitted by the User who input the case for Jane Doe. This information is shown in case information field 350 in FIGS. 10A and 22. Case information field 350 continues in FIG. 10B and includes Review of systems, medication(s) taken by the patient, current medical problems, and drug allergies, which is information that was input by the User previously. Case information field 350 continues in FIG. 10C and includes a History of skin problems for the patient. Case information field 350 also includes photographs 360, which are photos of the skin problem previously input by the User. Each photo has a descriptive label 370 that indicates the location of the skin problem as previously input by the User, as well as a user interface control 380 for Physician 1 to enter any comments about the photos.

FIG. 10D contains field 370 indicating any documents that had been loaded by the User for this patient. If a document is present, field 370 will include a link that Physician 1 can select to obtain the document. That document will be stored by server 50 in operational data store 670. Web page 340 includes user interface control 380 for Physician 1 to enter the diagnosis for the skin problem. Web page 340 also includes user interface control 390 for Physician 1 to enter the Assessment and Recommendations for that skin problem.

FIG. 10E contains text 400 that contains any questions input by the User, as well as user interface control 410 for Physician 1 to answer the question. It also contains user interface control 420 for Physician 1 to provide any follow-up recommendations.

The left side of web page 340 contains links for “Chart,” “Demographics,” “Documents,” “Medical History,” and “Current Encounter.” If Physician 1 selects any of these links, server 50 will generate a web page. The web page generated for Current Encounter is web page 340.

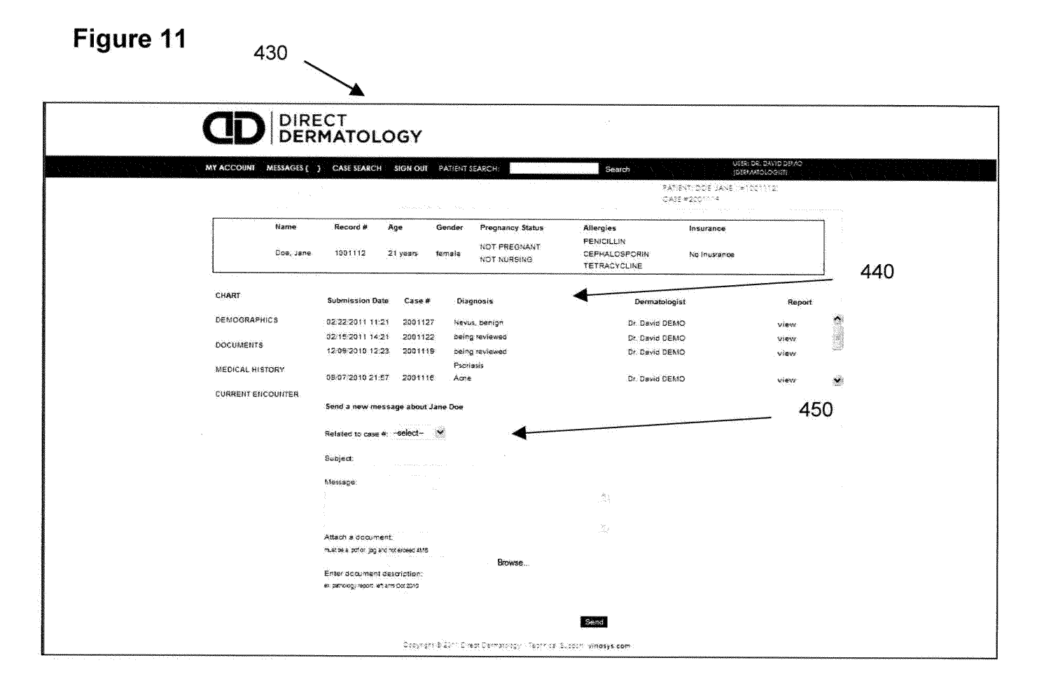

FIG. 11 shows a screen shot of exemplary web page 430 that is generated when Physician 1 selects the “Chart” link. Web page 430 shows the “Chart” for Patient 1 and includes case information 440 for that patient, which includes for each case the submission date, case number, diagnosis, physician (dermatologist) and report. If a report has been created for a particular case, a link titled “view” is made available. If Physician 1 selects that link, the appropriate report will be obtained from operational data'store 670 and displayed on a web page. The case numbers are uniquely assigned using the method described below. Web page 430 includes message input feature 450 that enables Physician 1 to create and send a message for the User associates with the patient, including the ability to attach a document.

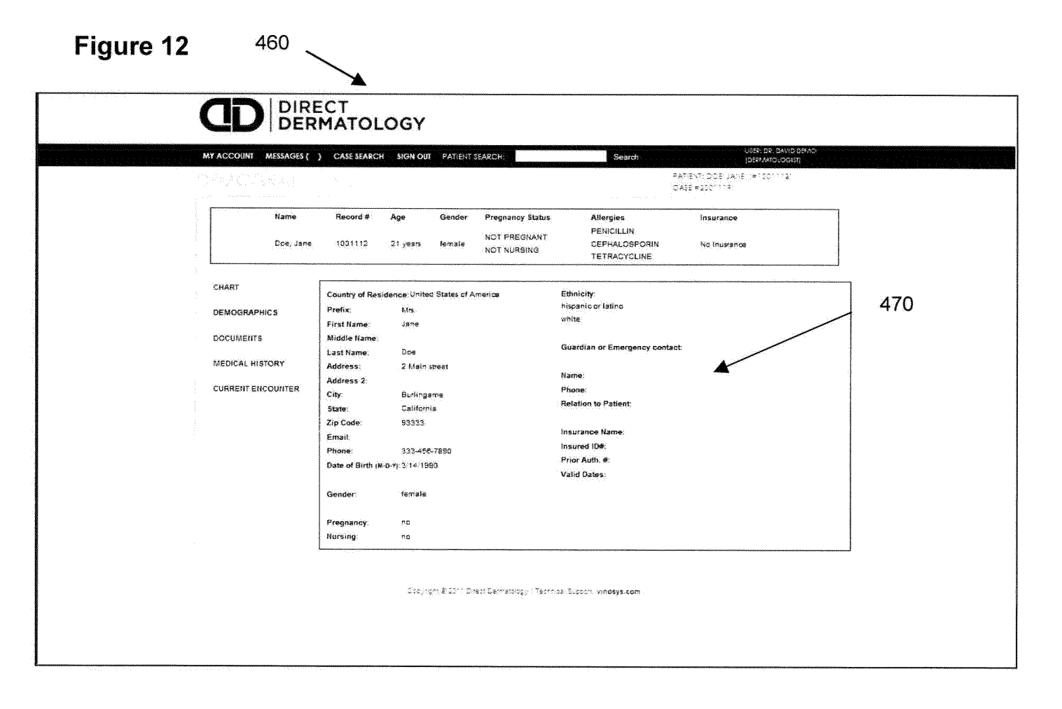

FIG. 12 shows a screen shot of exemplary web page 460 that is generated when Physician 1 selects the “Demographics” link. Web page 460 includes demographic information 470 that was obtained from the User during the case input process.

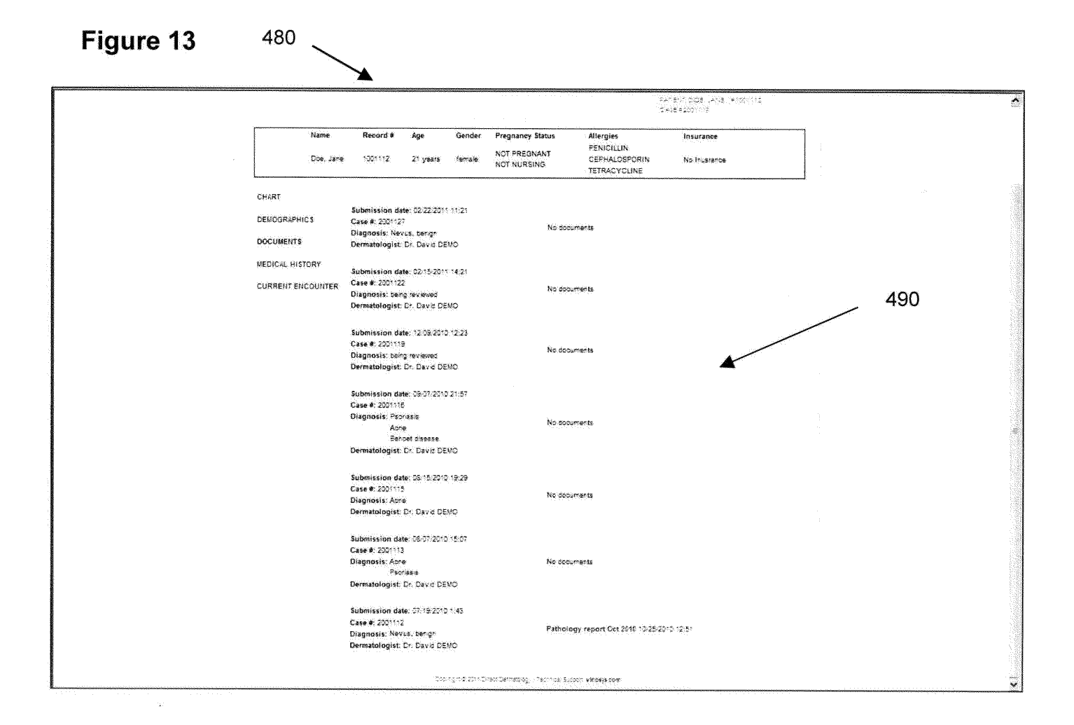

FIG. 13 shows a screen shot of exemplary web page 480 that is generated when Physician 1 selects the “Documents” link. Web page 480 includes document information 490 regarding all documents relating to that Patient, as well as links to documents when available.

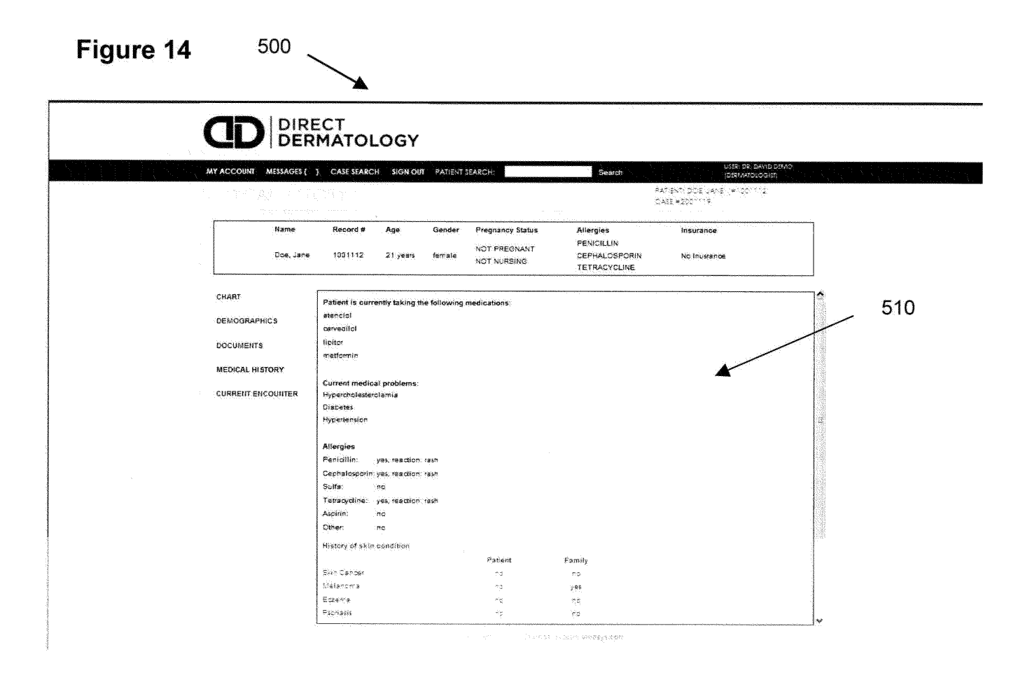

FIG. 14 shows a screen shot of exemplary web page 500 that is generated when Physician 1 selects the “Medical History” link. Web page 500 includes medical history information 510 regarding the Patient's medical history.

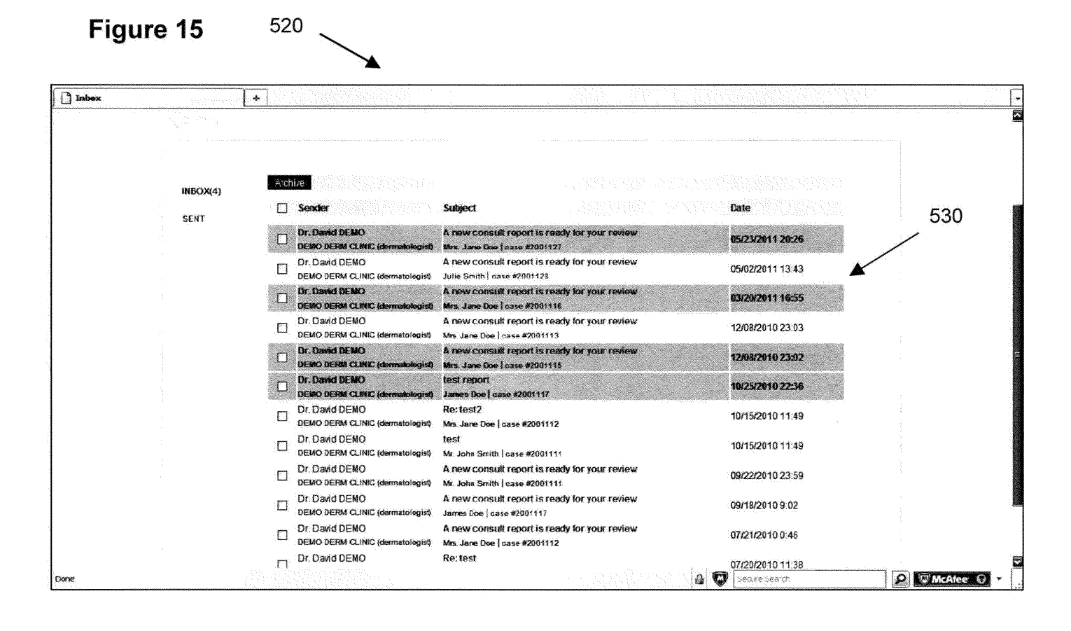

FIG. 15 shows a screen shot of exemplary web page 520 that is generated when Physician 1 selects the “Inbox” feature from any menu. Web page 520 displays inbox 530, which shows each message that has been sent to Physician 1 by a User, an Admin, or by server 50. Physician 1 can select a message to view it.

After completing the case in consultation module 340, Treating Physician 1 fills in a survey generated by statistic engine 740 shown on FIG. 22, and server 50 stores the information in operational data store 670.

Notification engine 730 shown on FIG. 22 sends out one or more notification emails to inform User 1 that Treating Physician 1 has completed the case.

Notification engine 730 also notifies Users when they have a new message in their secure inbox. More generally, notification engine 730 generates automated messages in situations such as when a quality control rule has been violated or is about to be violated (e.g. a case has been sitting in the queue for too long), a new case is ready for review, a new diagnosis/recommendation is ready for review, an urgent case has been submitted, or a follow-up is in a Treating Physician queue.

User interface controls describes above, such as user interface controls 310, 330, 380, 390, 410, and 420, comprise web browser interfaces well-known to those of skill in the art, such as HTML or XHTML text boxes; menus, links, and buttons.

Other Technical Architecture Details of the Telemedicine System

FIG. 16 shows additional aspects of an embodiment. Server 50 is coupled to database 60 and content management system 70. Database 60 and content management 70 can be physically contained within the same computing system as server 50, or they can be contained in separate computing systems (as might be the case in a cloud system). Server 50 can be configured to receive external data feeds from external computing devices 600. External computing devices 600 optionally comprise a drug database 610, physician database 620, and pharmacy database 630.

Drug database 610 can contain information about FDA-approved medications, which would enable server 50 to provide information about those medications to the Treating Physicians and optionally to restrict the medications prescribed by the Treating Physicians to those drugs that are contained in drug database 610. Data from drug database 610 can be used by server 50 to resolve drug names when Patients are inputting exiting medications used or when Treating Physicians are prescribing medications, such as by using an ajax drop down menu as the person begins to type in the drug name.

Physician database 620 can contain information from medical encyclopedias, reference guides, treatises, and other sources of medical knowledge to assist physicians in their treatment and diagnoses of various skin conditions.

Pharmacy database 630 can be operated by a pharmacy website that enables the Physician to order medication for a Patient by using server 50. This would enable the Physician to provide the medication to the Patient in a seamless manner.

Server 50 can generate user interfaces 650, which includes a Patient user interface, Physician user interface, and an Admin user interface, as described previously with respect to FIGS. 2-15.

Server 50 optionally runs software modules 660 that implement a multitude of services. Software modules 660 comprise lines of code that are executed by server 50 and preferably are written in the PHP, Python, C, C++, or JAVA programming languages. Examples of such services are described in Table 1:

TABLE 1

| Title of Software Module | Description |
|---|---|
| Account Management | Manages information for each Patient. |
| Case/PHR Management | Manages information for each case. |
| Image Management | Manages photos uploaded by Patients or |
| | Primary Physicians. |
| Scheduling Module 661 | Assigns cases to Treating Physicians. |
| Configure Choices, | Establishes the rules and procedures by which |
| Rules, Values | the Scheduling Module performs its |
| | assignments. |
| Survey Management | Implements surveys for Patients, Primary |
| | Physicians, and Treating Physicians, so that the |
| | Admin can receive helpful feedback regarding |
| | the system. |
| Follow-up Engine | Follows up with Patients, Primary Physicians, |
| | and Treating Physicians to regarding treatment |
| | of patients and conditions. |
| Contract Management | Organizes contracts between the operator of |
| | server 50 and the Patients, Primary Physicians, |
| | and Treating Physicians. |
| Incentive Management | Implements an incentive system to motivate |
| | Treating Physicians to review their cases in a |
| | timely manner. |
| Outbound E-mail/Fax | Manages e-mails and faxes sent by Patients, |
| | Primary Physicians, and Treating Physicians. |
| Patient/Doctor E-mail | Manages e-mails between Patients and |
| | Treating Physicians or between Primary |
| | Physicians and Treating Physicians and |
| | ensures their security and confidentiality. |
| Search | Provides a search tool to search within the |
| | content of the websites offered by server 50 as |
| | well as the underlying content of server 50 and |
| | content database 60. |
| Chat | Provides chat feature for Patients, Primary |
| | Physicians, and Treating Physicians. |
| Security | Ensures security of Server 50, Content |
| | Database 60, Content Management System 70, |
| | and all data contained therein. |
| Logging & Auditing | Creates logs of all events. |
| Insurance Gateway | Provides a portal by which to communicate |
| | with insurance companies to coordinate billing |
| | to insurance companies. |
| Payment Gateway | Provides a portal to access a payment |
| | processor to bill each Patient, such as to collect |
| | an insurance co-payment. |

Additional aspects of Scheduling Module 661 (described in Table 1, above) will now be discussed. During operation, server 50 might receive many different cases from numerous Users, and it also may need to interact with numerous Treating Physicians. Scheduling Module 661 preferably creates a queue for Treating Physician and assigns each new case to the Treating Physician that is best suited for treating that Patient and for completing the case within a predetermined temporal threshold.

Under the current medical regulatory framework, each State regulates all medical services that are performed within its borders. In the telemedicine context, the physical location of the Patient is typically the location used to determine which State has jurisdiction over the medical services to that Patient. Each State typically requires that anyone who provides medical services within its borders must be a registered medical doctor with that State. Thus, when the telemedicine services of the embodiments are provided, each Patient must be assigned to a Treating Physician who is licensed in the State where the Patient is physically present when the case is created, photos uploaded, etc. Thus, Scheduling Module 661 can be configured to consider any of the following factors: physical location of Patient; States in which each Treating Physician is licensed; the nature of the skin condition; the expertise of each Treating Physician; the medical specialties and sub-specialties for which each Treating Physician has certification; the length of the current queue for each Treating Physician; the average waiting time of each case for each Treating Physician; and whether the Patient is associated with a particular Primary Physician, clinic, insurance company, or hospital that requires special treatment or assignments (for example, it may be desirable to assign all cases from a particular clinic to the same Treating Physician or set of Treating Physicians). An Administrator can create a threshold representing the maximum acceptable waiting time for each case (e.g., 48 hours) in which it must be reviewed and completed by a Treating Physician. The Administrator also can create a “red zone” threshold (e.g., 40 hours) representing the elapsed time for a case that will trigger priority treatment to place it in a higher location (such as the front of the queue) within a Treating Physician's queue or to assign the case to the “next available” physician who is licensed in the relevant State for that Patient.

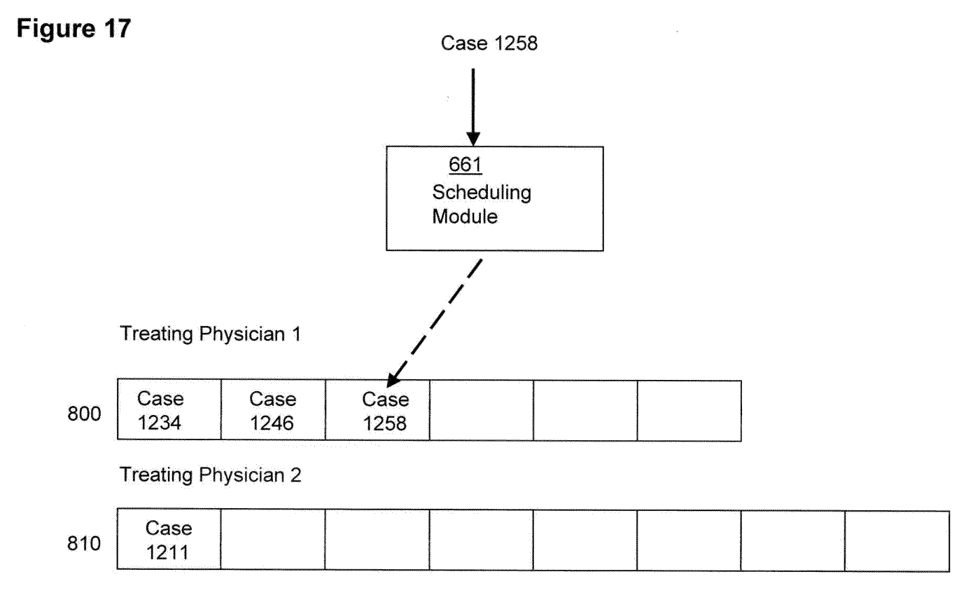

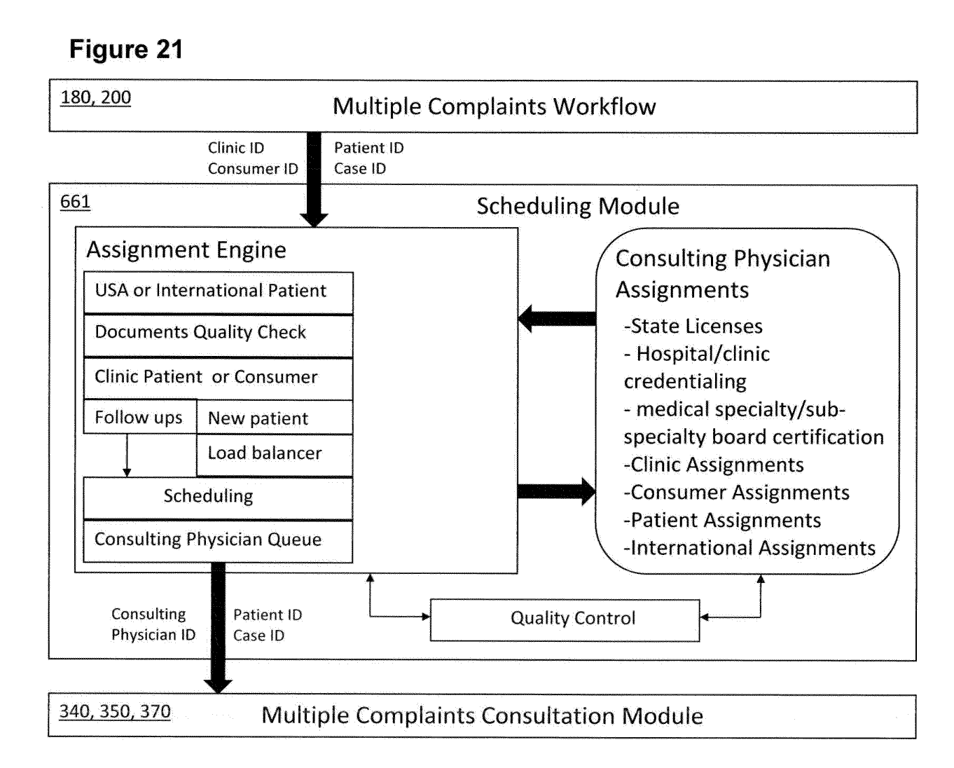

An embodiment of Scheduling Module 661 is shown in FIGS. 17 and 21. A new case is received, which server 50 assigns the Case ID “1258.” Each Treating Physician is associated with a queue managed by Scheduling Module 661. A queue can be implemented by a data structure stored in memory. In FIGS. 17 and 21, Treating Physician 1 is associated with queue 800, and Treating Physician 2 is associated with queue 810. Queue 800 contains two cases (Case IDs 1234 and 1246) and queue 810 contains one case (Case ID 1211). In this example, Scheduling Module 661 determines in which queue to place the new case with Case ID 1258. If Treating Physician 1 is licensed in the state in which the Patient is located and Treating Physician 2 is not, then Scheduling Module 661 will assign the case to queue 800, as shown in FIG. 17. If Treating Physician 1 and Treating Physician 2 are both licensed in the relevant state, then

Scheduling Module 661 can take additional factors into account (as listed above) to determine in which queue to place the new case. This example obviously is a simplified one, and additional Treating Physicians with associated queues are contemplated.

Server 50 optionally comprises Operational Data Store 670. Operational Data Store 670 preferably is a relational database such as MySQL or an Oracle database. Operational Data Store 670 contains the data related to the telemedicine service. Software modules 660 utilize operational data store 670 to obtain the data needed to perform the various services. Operational data store 670 comprises numerous tables, each of which contains a set of data. The Case IDs, Primary Physician IDs, and Treating Physician IDs are used as keys to manage the data and tables.

Exemplary tables and their roles are described below in Table 2:

TABLE 2

| Table in Operational | |
|---|---|
| Data Store 670 | Description |
| Case Assignments | Data regarding which Treating Physician is |
| | assigned to each case. |
| Physician Schedules | Data regarding all Treating Physicians and |
| | their work schedules (i.e., the times when they |
| | will be available to review and work on cases). |
| Admin Configuration | Configuration information for server 50. |
| Surveys | Data from surveys for Patients, Primary |
| | Physicians, and Treating Physicians. |
| Contracts | Data regarding contracts between the operator |
| | of server 50 and the Patients, Primary |
| | Physicians, and Treating Physicians. |
| Incentives | Data regarding incentives motivate Treating |
| | Physicians to review their cases in a timely |
| | manner. |
| User Accounts | Profile information, medical history, and case |
| | information for each Patient and/or Primary |
| | Physician |
| Case/PHR Management | Data from Patients and Primary Physicians |
| | collected for a particular case |
| Images | Photos uploaded by Patients and Primary |
| | Physicians |

Server 50 optionally generates raw log files 680, which can comprise flat files or text files generated during operation of server 50. Examples of the types of data that can be collected in raw log files 680 include information such as user ID, Patient ID, Case ID, Primary Physician ID, Treating Physician ID, document ID, and timestamps, as well as data or metadata associated with events and activities by the user or any component of the system.

Server 50 optionally includes scripts 690. Scripts 690 are lines of code that process data obtained from raw log files 680, operational data store 670, and external data feeds 600. Scripts 690 preferably are written in the PHP, Python, C, or JAVA programming languages.

Server 50 optionally includes Historical Data Store 700, which is a database used to store data generated or parsed by scripts 690. Historical Data Store 700 optionally comprises audit tables so that Administrators can verify the accuracy of the data generated by server 50 and stored in Historical Data Store 700, as well as Reporting Tables so that an Administrator can receive and view Internal reports 710. Examples of internal reports 710 include reports that describe the flow of cases, the average case time by Treating Physician, number or percentage of times a Treating Physician has rejected a case for needing “more information,” the number or percentage of times a doctor has referred a patient for a live visit, satisfaction surveys, and any other data collected by server 50.

Historical Data Store 700 optionally comprises a billing database containing data for billing purposes, which is then processed and presented by Billing User Interface 720.

FIG. 18 shows the manner in which an embodiment performs I/O Management.

FIG. 19 shows the manner in which an embodiment manages patient data, cases, and complaints.

FIG. 20 shows a workflow for handling multiple complaints within a single case on the Patient side of the system.

FIG. 21 shows additional detail for an embodiment of scheduling module 661.

FIG. 22 shows a workflow for handling multiple complaints within a single case on the Treating Physician side of the system.

While the foregoing has been with reference to particular embodiments of the invention, it will be appreciated by those skilled in the art that changes in these embodiments may be made without departing from the principles and spirit of the invention, the scope of which is defined by the appended claims.

1. A system for providing dermatologic telemedicine services comprising:
a server configured to receive information for a new dermatologic case over a network, wherein the server comprises an assignment module for assigning the case to one of a plurality of treating physicians;
wherein said information comprises digital photos of a patient's skin condition;
wherein said assignment module comprises lines of code to create a queue for each of said plurality of treating physicians and to place the case in at least one of the queues; and
wherein said server is coupled to a data store for storing said information.

2. The apparatus of claim 1, wherein the system further comprises a computer for sending said digital photos to the server over the network.

3. The apparatus of claim 2, wherein the computer is configured to receive a portion of the information from a patient and to send said portion of the information to the server over the network.

4. The apparatus of claim 1, wherein the system further comprises a second computer for receiving a diagnosis for the case from the one of said plurality of treating physicians and for sending the diagnosis to the server.

5. The apparatus of claim 2, wherein the system further comprises a second computer for receiving a diagnosis for the case from the one of said plurality of treating physicians and for sending the diagnosis to the server.

6. The apparatus of claim 1, wherein the data store comprises a relational database.

7. The apparatus of claim 2, wherein the data store comprises a relational database.

8. The apparatus of claim 3, wherein the data store comprises a relational database.

9. The apparatus of claim 4, wherein the data store comprises a relational database.

10. The apparatus of claim 5, wherein the data store comprises a relational database.

11. A method for providing dermatologic telemedicine services comprising:
receiving, by a server, information for a new dermatologic case over a network, wherein said information comprises digital photos of a patient's skin condition;
maintaining, by the server, a queue for each of a plurality of treating physicians;
placing, by the assignment module, the case into at least one queue;
storing said information in a data store coupled to the server.

12. The method of claim 11, further comprising sending, by a computer, said digital photos to the server over the network.

13. The method of claim 12, further comprising receiving, by the computer, a portion of the information from a patient and sending, by the computer, said portion of the information to the server over the network.

14. The method of claim 11, further comprising receiving, by a second computer, a diagnosis for the case from the one of said plurality of treating physicians and sending, by the second computer, the diagnosis to the server.

15. The method of claim 12, further comprising receiving, by a second computer, a diagnosis for the case from the one of said plurality of treating physicians and sending, by the second computer, the diagnosis to the server.

16. The method of claim 11, wherein the data store comprises a relational database.

17. The method of claim 12, wherein the data store comprises a relational database.

18. The method of claim 13, wherein the data store comprises a relational database.

19. The method of claim 14, wherein the data store comprises a relational database.

20. The method of claim 15, wherein the data store comprises a relational database.
